(19) United States
(12) Patent Application Publication
(10) Pub. No.: US 2018/0173196 A1
(43) Pub. Date: Jun. 21, 2018

(54) PRODUCTION MACHINE AND OPERATING METHOD FOR A PRODUCTION MACHINE

(71) Applicant: Océ Holding B.V., Venlo (NL)

(72) Inventor: Joerg Schmidt, Muenchen (DE)

(73) Assignee: Océ Holding B.V., Venlo (NL)

(21) Appl. No.: 15/850,992

(22) Filed: Dec. 21, 2017

(30) Foreign Application Priority Data
Dec. 21, 2016 (DE) 10 2016 125 154.2

(51) Int. Cl. G05B 19/409; G05B 19/19; G05B 19/414

(52) U.S. Cl. CPC G05B 19/409; G05B 2219/36154; G05B 19/4148; G05B 19/19

(57) ABSTRACT

A production machine can be operated with one or more touchscreens that are mounted on lateral surfaces of the production machine. The position of an operator can be determined with at least one first sensor. The position of a control panel for the production machine that is displayed on the at least one touchscreen is adapted to the position of the operator.

### CROSS REFERENCE TO RELATED APPLICATIONS

This patent application claims priority to German Patent Application No. 102016125154.2, filed Dec. 21, 2016, which is incorporated herein by reference in its entirety.

BACKGROUND The present disclosure is related to a production machine having at least one touchscreen for operation, a method for operation of the production machine, and a system including production machine.

WO 2014/008185 A1 describes a TV system whose display adapts to the position of the observer.

In larger production installations, in particular digital printing machines, the operators may be staying at various locations, even at a greater distance from the production machine. The operating elements and displays are therefore implemented multiple times and mounted at various locations of the production installation in order to reduce the distance operators may travel to such elements and displays, and to enable a quick engagement given a need for action.

It has been shown that separate operating elements are not always sufficient to enable a fast engagement by the operators. For example, given stationary notification lights (e.g. alarms), it may occur that these are obstructed from the operators by other machines, building elements etc., and cannot be perceived by the operators. It may thus occur that, in spite of an active alarm indicator, an operator may not take a necessary reaction, the reaction may be late, or may not happen at all.

Other indicator elements may often be imperceptible if a certain distance between operator and indicator element is exceeded.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 shows a three-dimensional illustration of a production machine according to an exemplary embodiment of the present disclosure.

FIGS. 2-4 show control panels according to exemplary embodiments of the present disclosure.

FIGS. 5a and 5b show perspective illustrations from two different standpoints/viewpoints of the production machine according to exemplary embodiments of the present disclosure.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

The present disclosure relates to an operating method for a production machine (e.g. printing system including one or more printers), a production machine, and a system for operating a production machine, which address the issues discussed above.

In an exemplary embodiment, the production machine includes at least at one lateral surface with a touchscreen that is configured to be situated in the field of view of an operator of the production machine. In an exemplary embodiment, the touchscreens are mounted surrounding the production machine, such as on all lateral surfaces of the production machine that face towards a region of space in which an operator may be staying (e.g. where the operator is located). These touchscreens can be configure to display a control panel at which an operator can administer production jobs for a production machine, for example, or makes other interventions at the production machine.

In the disclosure, the production machine has a height of, for example, starting at approximately 1.20 m, but is not limited thereto and the machine can be of various heights. In this example, the lower edge of the touchscreen(s) may be located at a height of, for example, at least 80 cm above the floor (e.g. at a typical height of a table), but is not limited thereto.

Depending on the lateral extent of the production machine, it may be necessary to arrange multiple touchscreens next to one another or atop one another. In this example, the touchscreens can have a limited or no outer frames (i.e. bezels) so as to provide a borderless arrangement. It is thus possible that a displayed control panel may be freely positioned across multiple touchscreens. In particular, it is possible to arrange the touchscreens so that they do not cover the openings for material and/or product at the lateral surfaces of the production machine, but are otherwise positioned circumferentially on all lateral surfaces on all sides of the production machine that face toward the spatial regions in which an operator typically stays.

In an exemplary embodiment, in a building in which the production machine is installed, at least one first sensor is installed which is configured to detect a spatial position of at least one operator. The first sensor can be stationary. This first sensor may, for example, be a camera whose image is evaluated to detect the location/position of the operator. The first sensor is not limited to a camera and can be one or more other position sensors as would be understood by one of ordinary skill in the art. In an exemplary embodiment, the first sensor includes processor circuitry that is configured to perform one or more operations of the sensor, including detecting a spatial position and generating (and transmitting) a sensor signal corresponding to the detected position.

Alternatively or additionally, a first sensor may be configured to exchange signals with a second sensor carried by the operator. An example of this exchange of signals is bidirectional communication using, for example, Bluetooth low energy (BLE) or other technologies as would be understood by one of ordinary skill in the art that are configured to determine distance or position of a participant in the communication. In an exemplary embodiment, the distance or position can be determined using measurements of the signal strength and/or triangulation or trilateralization.

The second sensor may be beacon (e.g. an iBeacon) that is configured to transmit an identifier that can be received by the first sensor and used by the first sensor to determine the portion of the second sensor. For example, the beacon may be stowed comfortably on the operator (e.g. in the pocket of an article of clothing). In this example, as a first sensor at least one sensor such as a minicomputer (e.g. a Raspberry Pi) equipped and configured to receive the signals of the beacon is used. Three minicomputers can be used to determine the position of a beacon in two dimensions. A three-dimensional determination of the position of the beacon can use four minicomputers. If more minicomputers are used, the precision of the determination of the position of the operator increases. In an exemplary embodiment, the second sensor includes processor circuitry that is configured to perform one or more operations of the second sensor, including receiving and processing information from the first sensor, and detecting a position of the first sensor (e.g. based on the information).

In an exemplary embodiment, the second sensor may be, for example, a smartphone or other mobile device, and the first sensor is at least one beacon. For example, multiple stationary first sensors then can be used (three to determine the position of a mobile device in two dimensions, four to determine the position in three dimensions). If more beacons are used, the accuracy of the determination of the position of the operator increases.

If a mobile device (e.g. smartphone, mobile telephone, smart watch, etc.) is used as a second sensor, the mobile device can include an application with which it determines its position from the signals of the beacons and transmits this via a wireless communication channel (e.g. a mobile radio network, WLAN, Bluetooth, etc.) to a position determiner connected with the production machine. Alternatively, the mobile device may relay the data of the beacon(s) via the communication channel to a position determiner connected with the production machine. The position determiner may then be configured to calculate the position of the mobile device. In an exemplary embodiment, the position detector includes processor circuitry that is configured to perform one or more operations of the position detector, including calculating the position of the mobile device. In an exemplary embodiment, the mobile device may be configured to determine its position with respect to one or more base stations or wireless access points (e.g. based on signal strength) and provide the determined position to the production machine. Alternative or additionally, the mobile device can include a global position system (GPS) sensor that is configured to determine the location of the mobile device using GPS technology. The determined position can be provided to the production machine.

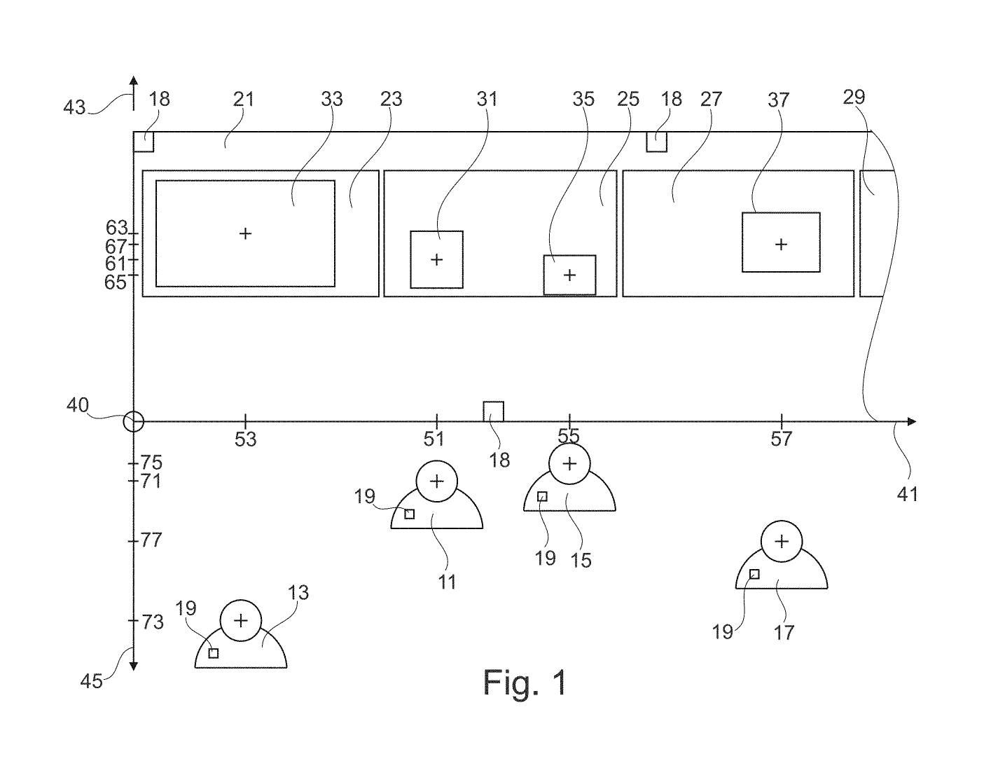

FIG. 1 illustrates an environment of production machine 21 and an operator 11, 13, 15 and 17 according to an exemplary embodiment of the present disclosure. In an exemplary embodiment, the production machine is a printing system, but is not limited thereto. The operator at various positions 11, 13, 15 and 17 with respect to (e.g. in front of) the production machine 21. In an exemplary embodiment, multiple touchscreens 23, 25, 27, 29 are mounted on the side of the production machine 21 facing the operators 11, 13, 15, 17. The touchscreens 23-29 can be configured to display statuses of the production machine 21 and its operation. The schematic three-dimensional depiction of FIG. 1 is not in perspective. The three spatial directions are indicated by the three coordinate axes 41, 43 and 45. The left lower corner of the production machine was selected as a coordinate origin 40. The coordinate axis for the spatial depth 45 was thereby depicted in the direction counter to the coordinate axis 43 for the height dimension. It is thus possible that, in one view, the position along the axis 41—thus the lateral extent of the production machine 21—may be clearly associated with both the height dimension along the axis 43 plotted upward and the spatial depth dimension along the axis 45 plotted downward relative to the drawing.

In an exemplary embodiment, three first sensors 18 that are configured to determine the respective position of the operator are located at the side of the production machine 21 that faces toward the operator, at which the touchscreens are also mounted. The schematically depicted operator respectively carries a second sensor 19.

If, as depicted in FIG. 1, the operator 11 is located relatively near to the production machine 21, the control panel 31 is displayed at the touchscreen 25 located closest to the position 11 of the operator, and at the position 51 in which the operator is located in the direction of the extent of the production machine 21. Due to the distance 71 at which the operator at position 11 is located from the production machine 21, the control panel 31 is indicated on the touchscreen 25 in the depicted size at the height 61.

If the operator moves into the position 13, the operator is now located at a greater distance 73 from the production machine 21 and at the position 53 in the direction of the extent of the production machine 21. The control panel 33 is now accordingly displayed on the touchscreen 23 at the position 53 in the direction of the extent of the production machine 21. Due to the greater distance 73, the control panel 33 is now also displayed at a greater height 63 (compared to the control panel 31). In an exemplary embodiment, the displayed size of the control panel is automatically adjusted based on the distance between the touchscreen and the operator. Additionally, the touchscreen at which the control panel is displayed can be automatically selected based on the position of the operator with respect to the production machine 21 and the corresponding positions of the touchscreen disposed thereon. Advantageously, the control panel size and location with respect to the operator can be optimally adjusted to facilitate operational control of the production machine 21 by the operator.

For the operator in position 15 or 17, the control panel 35 or 37 is displayed in a size corresponding to the distance 75 or 77 on the touchscreen 25 or 27 at the position 55 or 57 in the direction of the extent of the production machine and at the height 65 or 67. Measured horizontally, thus in relation to the coordinate axes 41 and 45, the respective middle positions (identified with a cross) of the control panels 31, 33, 35, 37 hereby have the least distance from the operator in the respective position 11, 13, 15, 17.

In an exemplary embodiment, the size of the displayed control panels designated with 31 and 35 differs only slightly since the distances from the position of the operator 11 and 15 are relatively small. In these instances, the operator is already standing just in front of the production machine 21. In an exemplary embodiment, the size of the control panel is not further reduced if the operator stays in a position below a certain established minimum distance.

In an exemplary embodiment, the position of the operator is determined based on wireless signals that are exchanged between the operator and the production machine 21. For example, electrical transmitters can be used, such as beacons. In an exemplary embodiment, a beacon (e.g. iBeacon) transmitter that operates according to the Bluetooth Low Energy (BLE) protocol is worn on the body of (or otherwise associated with) the operator, for example in a pocket of an article of clothing. In this example, the beacon is designated as a second sensor.

In an exemplary embodiment, at least one minicomputer (or other computer, processor, or the like) that is configured to receive the beacon signal from the beacon(s) is then mounted at the production machine 21 and/or at least at one other location of the production machine environment (e.g. building in which the production machine 21 is installed). This receiving computer is referred to as a first sensor 18. The computer 18 is configured to determine the position of the operator from one or more signals from the beacon 19, either via triangulation in cooperation with the other receiving computers 18, or from the signal strength of the signal(s).

In an exemplary embodiment, alternatively to or additionally from the computer 18, the position determination may be performed by a separate computer or by a controller of the production machine 21, for example. In the example of FIG. 1, three minicomputers 18 are shown to determine the position of beacon 19 in two dimensions. A three-dimensional determination of the position of the beacon 19 can be performed using four minicomputers 18. If more minicomputers 18 are used, the precision of the determination of the position of the operator increases.

In an exemplary embodiment, the precision of this position determination may be considerably increased via the provision of multiple computers. For example, if these devices transmit the information of the beacon via a network to a computer designated for the evaluation of the signals of the beacon that are received by all computers or smartphones. This computer may be one of the receiving computers or also a superordinate control computer, in particular the control computer for the operation of the production machine 21 or the control computer of the production machine 21 itself.

In an exemplary embodiment, one or more beacon transmitters (as sensors 18) are mounted at the production machine 21 or at other locations of the building in which the production machine 21 is installed. The operator of the production machine 21 is equipped with a mobile device (e.g. smartphone). The mobile device can be configured to determine the position of the operator (e.g. using an app) based the signals from one or more of the beacons 18. The mobile device can be configured to send signal strengths and/or directions with or from which the mobile device receives the signals of the beacons to a position determiner. The position determiner may, for example, be accommodated in a controller of the production machine 21, in the form of a special computer or a program that is executed by the controller. In an exemplary embodiment, the beacons can include iBeacons, Eddystones, AltBeacons, or one or more other beacon-type devices as would be understood by one of ordinary skill in the relevant arts.

The present disclosure is not limited to Bluetooth technologies, and can be configured for one or more alternative or additional radio technologies (which can be used for position determinations), such as Radio-frequency identification (RFID), WiFi, Z-wave, Zigbee, WiMax, one or more cellular technologies, or other technologies as would be understood by one of ordinary skill in the relevant arts.

In an exemplary embodiment, the position of the operator may also be determined based on a detection with a camera system. For example, the camera system can serves as a first sensor 18. One example of such a system is sold by Microsoft under the name Kinect, but the system is not limited thereto. Other camera systems may also be used that are configured to stereoscopically determine the position of the operator. In this example, the camera systems includes at least two monocular cameras. Given extended production machines, due to the limited aperture angle of camera objectives (which determines the field of vision) and other technical limitations, the system can include multiple cameras (e.g. more than 2) that are configured to record all spatial areas in which an operator may be staying (e.g. areas around the machine where the operator may be located).

In an exemplary embodiment, to differentiate the operator from other persons in the field of view of the camera, an image evaluator can be provided that is configured to evaluate the camera images to identify recognized persons. The image evaluator can include image evaluation software in one or more embodiments that is configured to perform one or more image recognition operations. In an exemplary embodiment, one or more operators can be equipped with at least one optical marker that may be designed as, for example, a reflector (e.g. a cube corner reflector) and/or to use technologies referred to as motion capture or eye capture. In this embodiment, the optical marker then serves as a second sensor 19.

In an exemplary embodiment, markers and/or beacons may be mounted on, for example, safety equipment (e.g. helmet, safety glasses, etc.) of the operator of the production machine 21.

In an exemplary embodiment, the position of the operator may also be determined using a laser tracker as a first sensor 18, or another tracking technology.

In an exemplary embodiment, gyroscopes (for example in a MEMS technology) or other accelerometers may likewise be used to determine the position of the operator in that the measured angular velocities are integrated once or the measured accelerations are integrated twice. Gyroscopes are also available in such a size that they may be installed in a housing together with a suitable transmitter and a battery for power supply and be carried along in pocket of an article of clothing by the operator. This housing with MEMS gyroscopes or accelerometers, battery and transmitter then serves as a second sensor 19. In this example, a single receiver as a first sensor 18 on the part of the production machine 21 is sufficient.

A combination of these technologies for determining the whereabouts (location, position, movement, etc.) of the operator is likewise possible as would be understood by one of ordinary skill in the relevant arts. The position/location of the operator may thus be determined both according to one of the exemplary embodiments, such as using electronic beacon(s) and computer or smartphone(s) to receive the signals of the beacon(s), and/or using a camera system for monitoring the production machine 21. In this example, the operator may, for example, carry both a beacon and a marker—attached to his helmet, for example—as a second sensor 19.

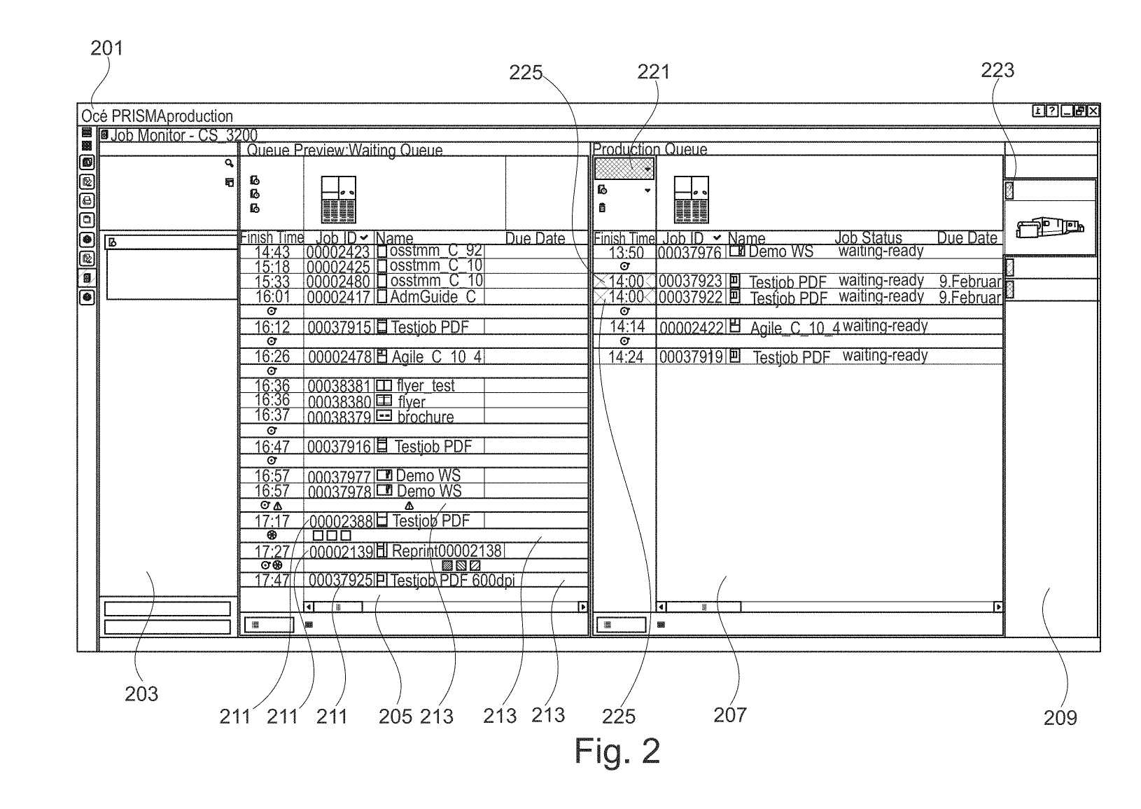

FIG. 2 illustrates a control panel of a production machine (e.g. printing system) according to an exemplary embodiment. The control panel can be represented by a graphical user interface (GUI) on a display screen, for example. The top row with the program name and the sidebar with a few buttons for quick operation, thus top bar and sidebar, are designated with 201. General information is located in column 203. A list of all pending jobs is depicted in column 205. The rows 211 of column 205 correspond to individual print requests, which are also referred to as jobs. Rows 213 that have dark backgrounds in this list designate measures that the operator must take. Such measures may be a changing of the paper or a filling with ink for print jobs of a different quality. Various printing machines may be selected in column 209. The jobs from this column 205 may be dragged into the column 207 via the menu control or with the mouse. They are thus associated with the printing machine that was previously selected in column 209. The print jobs immediately pending for processing have a red background in the presentation of the fields 225 because the printing machine is not active. This is also indicated by red backgrounds of the fields 221 and 223.

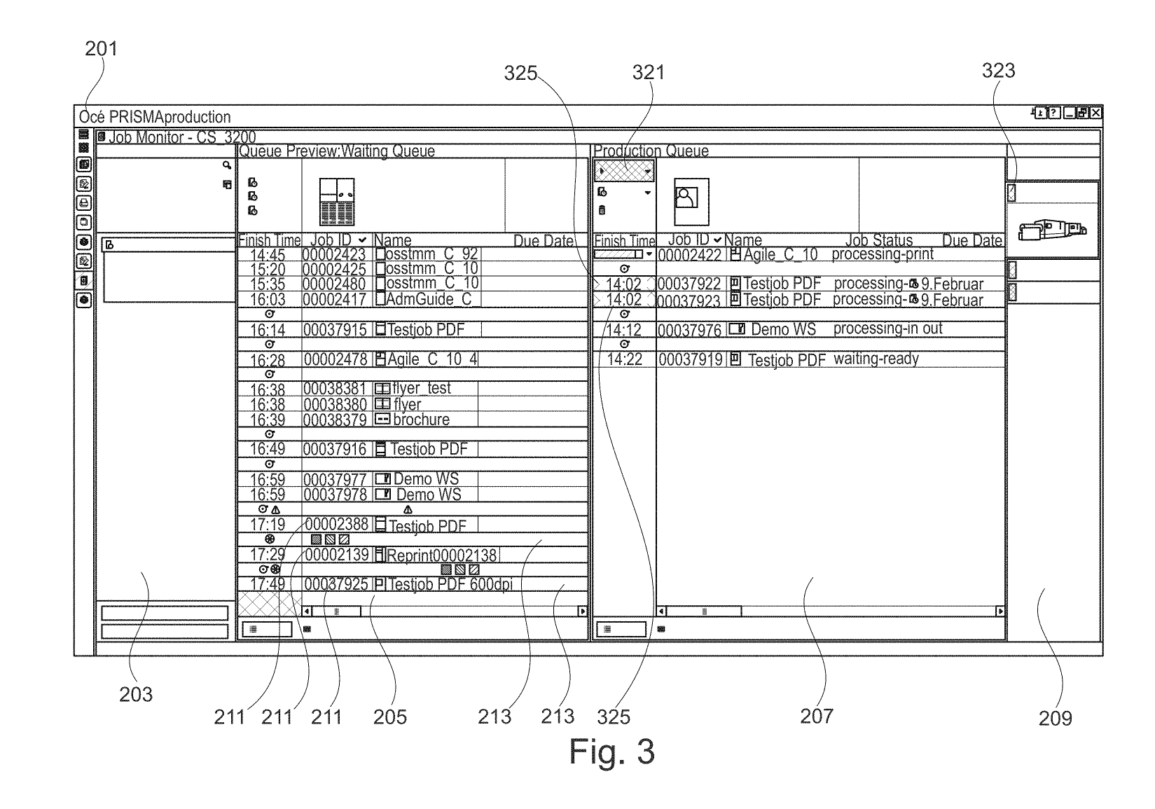

An additional example of a control panel is shown in FIG. 3, this time with an active printing machine. Here the regions 321 and 323 that were marked with red in FIG. 2 for the inactivity of the printing machine, as well as the regions 325 for the pending print jobs, have green backgrounds.

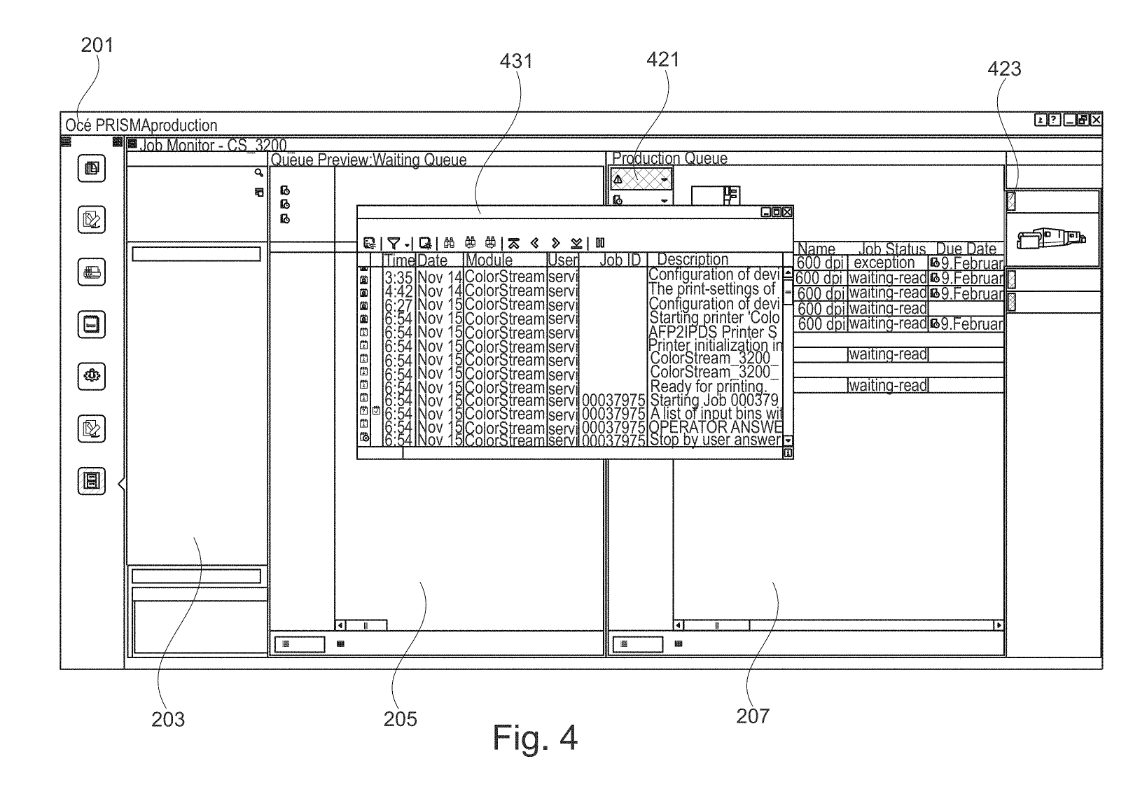

In FIG. 4, the presentation of the control panel is overlaid with a box 431 that depicts a notification list. The regions 421 and 423 that are shown red or green in FIG. 2 or 3 now have backgrounds in a different color, for example yellow, which should represent the existing interruption of the production.

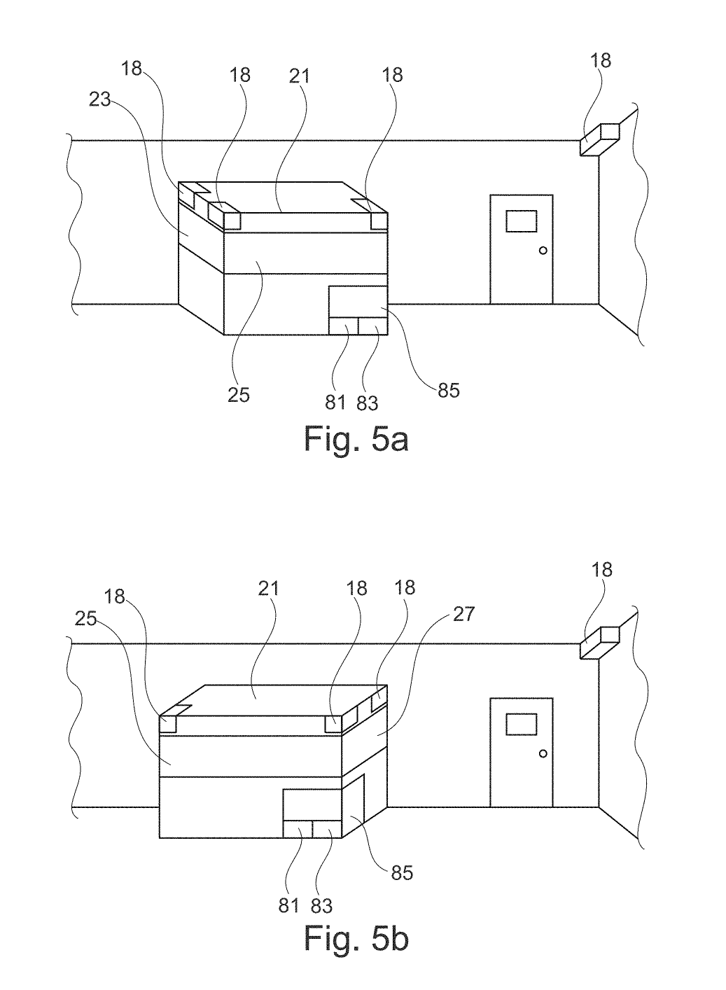

FIGS. 5a and 5b illustrate different perspective views of a printing machine according to exemplary embodiments. As shown, the printing machine is provided with touchscreens on three sides. The fourth lateral surface is facing toward a wall, behind which service functions are performed. In printing operation, no touchscreen for the operation of the printing machine is provided on this side of the printing machine. Shown is the production machine 21 with three first sensors 18, three touchscreens 23, 25 and 27, and a controller 85 into which are integrated a position determination 81 and a control panel controller 83. A fourth first sensor 18 is mounted in one corner of the room (upper right in FIG. 5).

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, “processor circuitry” can include one or more circuits, one or more processors, logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. In one or more exemplary embodiments, the processor can include a memory, and the processor can be “hard-coded” with instructions to perform corresponding function(s) according to embodiments described herein. In these examples, the hard-coded instructions can be stored on the memory. Alternatively or additionally, the processor can access an internal and/or external memory to retrieve instructions stored in the internal and/or external memory, which when executed by the processor, perform the corresponding function(s) associated with the processor, and/or one or more functions and/or operations related to the operation of a component having the processor included therein.

In one or more of the exemplary embodiments described herein, the memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

11, 13, 15, 17 operator in various positions

18 first sensor

19 second sensor

21 production machine (e.g. printer)

23, 25, 27, 29 monitor

31, 33, 35, 37 control panel

40 coordinate origin

41, 43, 45 coordinate devices

51, 53, 55, 57 x-coordinate, position of the operator

61, 63, 65, 67 z-coordinate, height of the middle of the display region

71, 73, 75, 77 y-coordinate, position of the operator

81 position detection

83 control panel controller

85 controller of the production machine

201 top and sidebar

203 column with overview

205 column with all pending jobs

207 column with jobs pending at the production machine

209 column with printing machines

211 row with print job

213 row with measure

221, 223, 225,

321, 323, 325,

421, 423 field with background color (display of the operating status of the machine)

431 box with notification list

1. A method for operating a production machine, comprising:
determining a position of at least one operator of the production machine using at least one stationary first sensor located in a building in which the production machine is installed;
calculating a distance of the at least one operator from the production machine based on the determined position;
determining a size of the control panel; and
displaying the control panel at the determined size on a monitor located at a position having a least horizontally measured distance from the at least one operator.

2. The method according to claim 1, wherein the size of the control panel is determined based on the calculated distance of the at least one operator from the production machine.

3. The method according to claim 2, wherein a predetermined minimum size of the control panel is maintained in response to the calculated distance falling below a predetermined distance of the at least one operator from the production machine.

4. The method according to claim 1, wherein the position of the at least one operator is determined using at least one second sensor carried by the at least one operator.

5. The method according to claim 4, wherein the at least one first sensor comprises at least three computers, and wherein the at least one second sensor is an electronic beacon.

6. The method according to claim 4, wherein the at least one first sensor comprises at least three electronic beacons, and wherein the at least one second sensor is a computer.

7. The method according to claim 6, wherein the at least three electronic beacons are arranged at the production machine.

8. A non-transitory computer-readable storage medium with an executable program stored thereon, wherein, when executed, the program instructs a processor to perform the method of claim 1.

9. A production machine, comprising:
at least one touchscreen configured to control operation of the production machine;
at least one stationary first sensor that is located in a building in which the production machine is installed,
a position detector that is configured to evaluate signals that are received by at least one sensor and determine a position of at least one operator based on the evaluated signals; and
a control panel controller that is configured to generate at least one control panel on the at least one touchscreen and arrange a center position of the generated at least one control panel on the at least one touchscreen so that a horizontally measured distance from the operator to the center position is minimized.

10. The production machine according to claim 9, wherein the control panel controller is further configured to adjust a size of the at least one control panel based on the horizontally measured distance from the operator.

11. The production machine according to claim 9, further comprising at least one second sensor that is carried by the operator.

12. The production machine according to claim 9, wherein the at least one touchscreen comprises multiple touchscreens arranged on one or more lateral surfaces of the production machine that face toward one or more corresponding spatial regions in which the operator may be staying.

13. A system for operation of a production machine, comprising:
a production machine;
at least one touchscreen disposed on the production machine and configured to control the operation of the production machine;
at least one stationary first sensor;
a position detector that is configured to evaluate signals that are received by the at least one sensor and to determine a position of at least one operator of the production machine based on the evaluated signals; and
a control panel controller that is configured to generate at least one control panel on the at least one touchscreen and arrange a center position of the at least one control panel on the at least one touchscreen so that a horizontally measured distance from the operator to the center position is minimized.

14. The system according to claim 13, wherein the control panel controller is further configured to adjust a size of the at least one control panel based on the horizontally measured distance from the operator.

15. The system according to claim 13, further comprising at least one second sensor that is carried by an operator.
